(19) United States
(12) Patent Application Publication
(10) Pub. No.: US 2012/0062822 A1
(43) Pub. Date: Mar. 15, 2012

(54) POLARIZING PLATE WITH A PHASE COMPENSATION FILM AND LIQUID CRYSTAL DISPLAY HAVING SAME

(76) Inventors: Hee Wook DO, Cheonan-si (KR); Duckjong SUH, Seoul (KR); Jung-Hun LEE, Seoul (KR); Boo-Kan KI, Seoul (KR); Min Oh CHOI, Asan-si (KR); Sang-Gu LEE, Seoul (KR)

(21) Appl. No.: 13/210,243

(22) Filed: Aug. 15, 2011

(30) Foreign Application Priority Data
Sep. 10, 2010 (KR) 10-2010-0089050

(51) Int. Cl. G02F 1/1335; G02F 1/13

(52) U.S. Cl. 349/96; 349/194

(57) ABSTRACT

A liquid crystal display includes a first substrate having a first alignment layer, a second substrate having a second alignment layer, a liquid crystal layer having liquid crystal molecules operating in a twisted nematic (TN) mode, a first polarizing film, a second polarizing film, and a phase difference compensation film. The phase difference compensation film has a delay axis to compensate for an undesired phase difference imposed by the NT operating liquid crystal layer on light, traveling through the liquid crystal layer when an ideally fully untwisting electric field is applied to the liquid crystal layer, and the delay axis forms an acute angle with a rubbing direction of the second alignment layer.

### CROSS-REFERENCE TO RELATED APPLICATION

This application relies for priority upon Korean Patent Application No. 2010-89050 filed on Sep. 10, 2010, the contents of which are herein incorporated by reference in their entirety.

### BACKGROUND

1. Field of Disclosure

The present disclosure of invention relates to a polarizing plate and a liquid crystal display having the same. More particularly, the present disclosure relates to a polarizing plate capable of improving a display quality and a liquid crystal display having the polarizing plate.

2. Description of Related Technology

In general, a liquid crystal display (LCD) includes two spaced apart substrates facing each other and a liquid crystal material layer disposed between the two substrates. Among the liquid crystal molecules which may be used in the liquid crystal layer, twisted nematic (TN) mode liquid crystal molecules are progressively twisted by up to 90 degrees when progressing through the liquid crystal layer and normally relative to the substrates while being kept axially in parallel to the two substrates when an electric field is not present between the two substrates. Also, when the electric field is generated between the two substrates, the TN mode liquid crystal molecules have their major axes aligned substantially perpendicular to the two substrates. The TN mode may be used to produce a white background when the electric field is off and black lettering on white background when the electric field is applied to pixels that are to appear black. Typically, polarization plates are at 90 degrees to each other when using TN mode and rubbing alignment is such as to encourage the progressive 90 degree twist of axial orientation of the liquid crystal molecules as between the upper and lower substrates.

Although a desired electric field is generated between the two substrates, in some cases alignment defects of the liquid crystal molecules occur nonetheless, thereby causing undesired refraction of passing through light due to the misaligned liquid crystal molecules and the consequently perturbed phase of the passing through light.

### SUMMARY

Exemplary embodiments in accordance with the disclosure provide a polarizing plate capable of improving a display quality of a liquid crystal display. Exemplary embodiments also provide a liquid crystal display having the polarizing plate.

According to one class of the exemplary embodiments, a polarizing plate for a liquid crystal display displaying an image using a liquid crystal layer operating in a twisted nematic mode includes an output polarizing film having a transmission axis directed in a first direction and a phase difference compensation film attached to the output polarizing film so as to apply a phase compensating twist to light traveled through the liquid crystal layer before the light is incident upon the output polarizing film. The phase difference compensation film has a delay axis that forms an acute angle with the transmission axis in a plan view.

According to one class of the exemplary embodiments, a polarizing plate for a liquid crystal display displaying an image using a liquid crystal layer operating in a twisted nematic mode includes a polarizing film having an absorption axis directed in a first direction, a phase difference compensation film attached to the polarizing film, and a viewing angle compensation film facing the polarizing film while interposing the phase difference compensation film. The phase difference compensation film has a delay axis that forms an acute angle with the absorption axis in a plan view.

According to one class of the exemplary embodiments, a liquid crystal display displaying an image using a light includes a first substrate having a first liquid crystal aligning layer, a second substrate facing the first substrate and having a second liquid crystal aligning layer, a liquid crystal layer disposed between the first and second substrates and including liquid crystal molecules operating in a twisted nematic mode, a first polarizing film facing the liquid crystal layer while interposing the first substrate therebetween, a second polarizing film facing the liquid crystal layer while interposing the second substrate therebetween, and a phase difference compensation film arranged between the second polarizing film and the second substrate.

The light sequentially travels through the first substrate, the liquid crystal layer, and the second substrate in such a manner so as to pass through the phase difference compensation film before striking the output (second) polarizing film. In addition, the phase difference compensation film has a delay axis which forms an acute angle with a rubbing direction of the second alignment layer in a plan view.

According to the above, when the liquid crystal display having the liquid crystal layer of which liquid crystal molecules are operating in a twisted nematic mode is driven the phase difference imposed by the liquid crystal may be compensated using the phase difference compensation film. Therefore, the phase difference of the liquid crystal layer may be compensated without increasing the dielectric anisotropy of the liquid crystal molecules or increasing the intensity of the electric field such that the long axis of each liquid crystal molecule is perpendicular to the substrate Thus, a responsiveness of liquid crystal molecules, which is in inverse proportion to the dielectric anisotropy of the liquid crystal molecules, may be enhanced and the intensity of the electric field needed for a predefined contrast ratio is reduced, thereby decreasing a power consumption.

### BRIEF DESCRIPTION OF THE DRAWINGS

The above and other advantages of the present disclosure of invention will become more readily apparent by reference to the following detailed description when considered in conjunction with the accompanying drawings wherein:

FIG. 1 is a cross-sectional view showing a liquid crystal display according to a first exemplary embodiment;

FIG. 2 is a cross-sectional view showing a pixel unit of a liquid crystal display of FIG. 1 when a white grayscale is to be displayed by the liquid crystal display;

FIG. 3A is a cross-sectional view showing a pixel unit of the liquid crystal display of FIG. 1 when a black grayscale is to be displayed by the liquid crystal display;

FIG. 3B is an enlarged view showing a liquid crystal in the environment of FIG. 3A;

FIG. 4 is a plan view showing exemplary polarization axes for the liquid crystal display of FIG. 1;

FIG. 5 is a graph showing a change in a contrast ratio of a liquid crystal display according to a level of a driving voltage;

FIG. 6 is a cross-sectional view showing a liquid crystal display according to another exemplary embodiment;

FIG. 7 is a cross-sectional view showing a liquid crystal display according to another exemplary embodiment;

FIG. 8 is a perspective view of a polarizing plate according to another exemplary embodiment; and

FIG. 9 is a perspective view showing a polarizing plate according to another exemplary embodiment.

### DETAILED DESCRIPTION

Hereinafter, the present teachings will be explained in more detail with reference to the accompanying drawings.

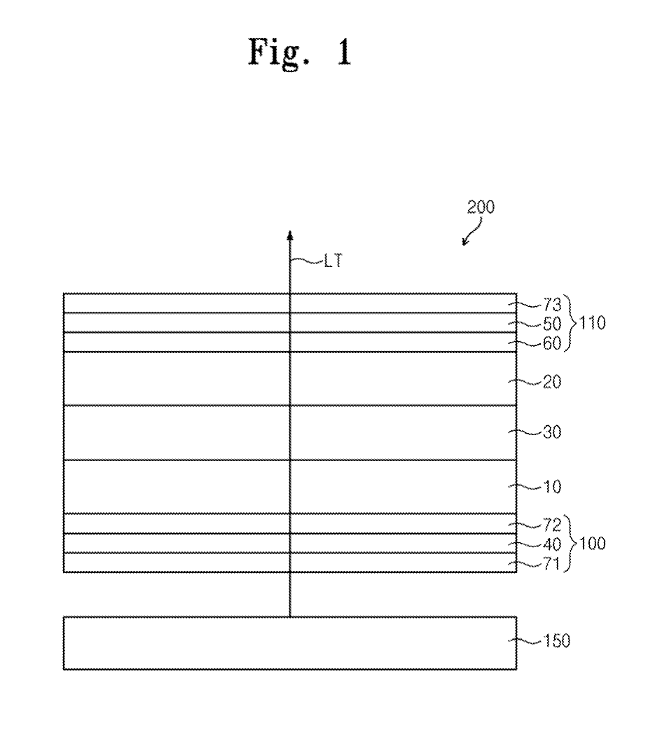

FIG. 1 is a cross-sectional view showing a liquid crystal display according to an exemplary first embodiment.

Referring to FIG. 1, a liquid crystal display 200 includes a first substrate 10, a second substrate 20, a first polarizing plate 100, a second polarizing plate 110, a liquid crystal layer 30, and a backlight unit 150. In the present exemplary embodiment, the liquid crystal display 200 displays an image using light rays LT (only one shown) that are generated by the backlight unit 150 and are sequentially transmits through the lower, first polarizing plate 100, through the first substrate 10 (e.g., TFT array substrate), through the liquid crystal layer 30, through the second substrate 20 (e.g., common electrode substrate) and through the second polarizing plate 110 for subsequent receipt by the eyes of a user (not shown).

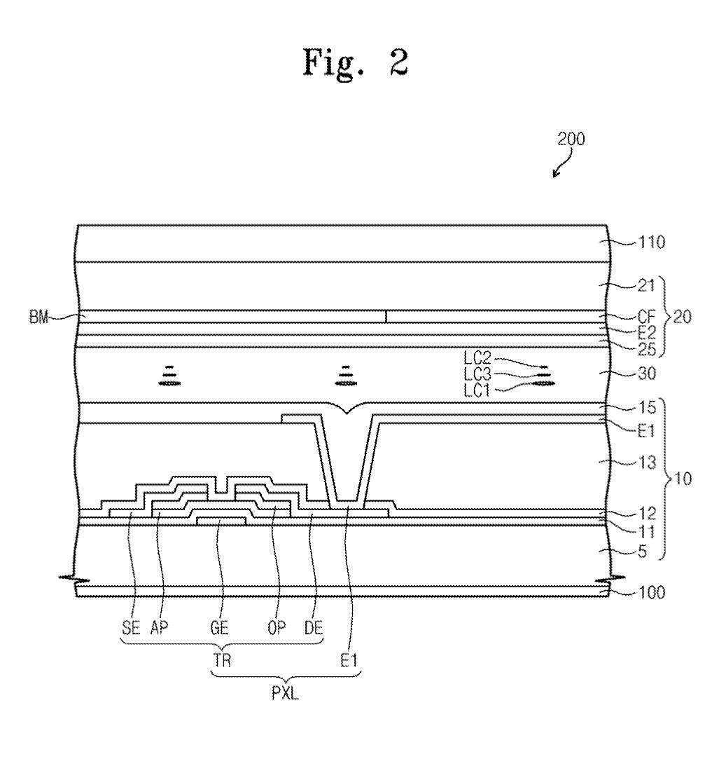

The first substrate 10 is arranged to be in facing electric cooperation with the second substrate 20. The first substrate 10 includes a plurality of individually changeable pixel units and the second substrate 20 includes a common electrode, color filters and a black matrix. An exemplary structure for the first and second substrates 10 and 20 will be described in detail shortly with reference to FIG. 2.

The liquid crystal layer 30 is disposed between the first substrate 10 and the second substrate 20. The liquid crystal layer 30 includes a plurality of liquid crystal molecules such as LC1, LC2, and LC3 (refer to FIG. 2) whose alignment states can be changed according to an electric field formed between the first substrate 10 and the second substrate 20. As a result of initial polarization by the lower, first polarizing plate 100, and change of polarization by the liquid crystal material layer 30 and further polarization by the upper, second polarizing plate 110, an amount of the light LT transmitted through the LCD assembly 200 may be controlled.

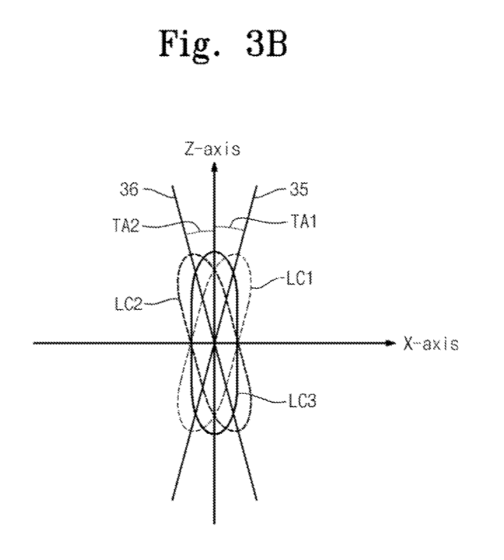

In the present exemplary embodiment, the liquid crystal layer 30 may include liquid crystal molecules that are operable in a twisted nematic (TN) mode. Ideally, if a fully untwisting electric field is applied to the liquid crystal layer, the liquid crystal molecules completely untwist from their no-field 90 degree twisted configuration and the light LT transmitted through the liquid crystal layer 30 experiences no refraction and thus arrives at an upper polarization plate (110 detailed more fully below) polarized at a perfect 90 degrees to the polarization axis (D2 in FIG. 4) of the upper polarization plate whereby the light LT is completely blocked and a black area of high contrast to surrounding white background is displayed. The ideal is not realized though even when the ideally fully untwisting electric field is applied to the liquid crystal layer, and the liquid crystal layer 30 does impart some polarization rotation on the passing through light, thereby disadvantageously reducing the contrast of displayed black grayscale relative to surrounding (background) white grayscale.

In the illustrated first embodiment of FIG. 1, the first polarizing plate 100 is attached to the lower first substrate 10 to face the liquid crystal layer 30 while interposing the first substrate 10 therebetween. The first polarizing plate 100 includes a first polarizing film 40, a first protective film 71, and a second protective film 72. The first polarizing film 40 linearly polarizes the light LT, and the first protective film 71 and the second protective film 72 are arranged to face each other while interposing the first polarizing film 40 therebetween to thereby protect the first polarizing film 40 from scratching and/or other defects.

The second polarizing plate 110 is attached to the upper second substrate 20 to face the liquid crystal layer 30 while interposing the second substrate 20 therebetween. The second polarizing plate 110 includes a second polarizing film 50, a phase difference compensation film 60, and a third protective film 73. The third protective film 73 functions to protect the second polarizing film 50 from scratching and/or other defects.

The second polarizing film 50 has a light-transmission allowing axis (not shown) that is substantially perpendicular to a light-transmission allowing axis (not shown) of the first polarizing film 40 where both light-transmission allowing axes are for allowing linearly polarized light LT of that respective angle (e.g., zero and 90 degrees) to pass through. Since in TN mode the liquid crystals provide a 90 degree twist with no electric field applied, the backlighting light is let through when no electric field is applied and a white background is displayed. The third protective film 73 faces the phase difference compensation film 60 while interposing the second polarizing film 50 therebetween to protect the second polarizing film 50 from scratching and/or other defects. In addition, the phase difference compensation film 60 is attached to the second substrate 20 and disposed between the second substrate 20 and the second polarizing film 50.

The phase difference compensation film 60 is positioned so as to change the polarization of the passing-through light LT before that light LT strikes the second (upper) polarizing film 50 and to thus compensate for a less than ideal phase difference (a non-zero phase difference) imposed on the passing through light LT by the liquid crystal layer 30.

Theoretically, when the maximum electric field (an ideally fully untwisting electric field) is generated between the first substrate 10 and the second substrate 20 to make a long axis of each of the liquid crystal molecules of the liquid crystal layer 30 to be perfectly perpendicular to the first substrate 10 and also to the second substrate 20, no phase difference should be imposed on the light LT as it transmits through the liquid crystal layer 30.

In general, however, since the long axis of each of the liquid crystal molecules is not perfectly perpendicular to at least one of the first substrate 10 or the second substrate 20, a non-zero phase difference may be imposed when the light LT transmits through the liquid crystal layer 30 while maximum electric field is applied. As a result, a less than fully black image is displayed contrary to the idealized TN operating mode. To this end, the phase difference compensation film 60 compensates for the phase difference of the light LT, which may occur by the liquid crystal layer 30.

In general, a material through which a light transmits has a refractive index, n, in an x-axis direction denoted as nₓ, in a y-axis direction denoted as n_{y}, and in a z-axis direction denoted as n_{z}. When the material has the same index of refraction in all directions, it is called an isotropic refractive index, and when the material has a different index of refraction in at least one of its directions, it is called an anisotropic refractive index. In the case that the material is provided as a film shape, a thickness direction of the film is referred to as the z-axis direction, and one of surface directions of the film is referred to as the x-axis direction, and one of the surface directions of the film, which is substantially perpendicular to the x-axis direction, is referred to as the y-axis direction.

In the present embodiment, the phase difference compensation film 60 has an index of refraction in the x-axis direction that is different from that of the y-axis direction, so the phase difference compensation film 60 has a phase difference value in a surface direction (R0) defined by the following equation.

R0=d×(nₓ−n_{y}), . . . nx≠ny [Equation]

In the above equation, d denotes a thickness of the phase difference compensation film 60, nₓ denotes a refractive index in the x-axis direction, and n_{y} denotes a different refractive index in the y-axis direction.

In the present exemplary embodiment, the phase difference value in the surface direction of the phase difference compensation film 60 may be about 3 nanometers to about 15 nanometers for the nominal wavelength light (e.g., Green), and the thickness of the phase difference compensation film 60 may be about 40 micrometers to about 80 micrometers. As an example, when the difference (nx−ny) between the refractive index of the x-axis direction and the y-axis direction of the phase difference compensation film 60 is about 0.00017 and the phase difference compensation film 60 has a thickness (d) of about 50 micrometers, the phase difference value (R0) in the surface direction is about 8.5 nanometers.

FIG. 2 is a cross-sectional view showing a pixel of the TN mode liquid crystal display of FIG. 1 when a white grayscale is to be displayed on the liquid crystal display while no electric filed is applied. The first substrate 10 includes a plurality of pixels thereon, however, since the pixels have the same structure and function, for the convenience of explanation, only one pixel will be described in detail, and thus detailed descriptions of other pixels will be omitted. In addition, in FIG. 2, the same reference numerals denote the same elements in FIG. 1, and thus the detailed descriptions of the same elements will be omitted.

The first substrate 10 includes a first base substrate 5, a pixel PXL, and a first (lower) alignment layer 15 in contact with the liquid crystal material 30. The first base substrate 5 has high transmittance, the pixel PXL is arranged on the first base substrate 5, and the first alignment layer 15 is arranged on the first base substrate 5 to cover the pixel PXL.

In detail, the pixel PXL includes a thin film transistor TR and a first electrode E1 electrically connected to the thin film transistor TR. The thin film transistor TR includes a gate electrode GE, an active pattern AP (semiconductive layer), a source electrode SE, a drain electrode DE, and an ohmic contact pattern OP. The active pattern AP is arranged on the gate electrode GE, the source electrode SE is arranged on the active pattern AP, and the drain electrode DE is arranged on the active pattern AP to be spaced apart from the source electrode SE. Also, the ohmic contact pattern OP is arranged between the source electrode SE and the active pattern AP and between the drain electrode DE and the active pattern AP.

Although not shown in FIG. 2, gate lines (not shown) that transmit a gate voltage and data lines that transmit a data voltage are arranged on the first substrate 10, the gate electrode GE is branched from one of the gate lines, and the source electrode SE is branched from one of the data lines. A gate insulating layer 11 is arranged on the first substrate 10 to cover the gate electrode GE, an insulative protective layer 12 is arranged on the first substrate 10 to cover the thin film transistor TR, and an organic layer 13 is arranged on the protective layer 12.

The first electrode E1 is arranged on the organic layer 13 and electrically connected to the drain electrode DE. More particularly, the protective layer 12 and the organic layer 13 are partially removed at the location of the contact hole to expose the drain electrode DE, and the exposed portion of the drain electrode DE is electrically connected to the first electrode E1. Thus, when the thin film transistor TR is turned on in response to the gate voltage applied to the gate electrode GE, the data voltage applied to the source electrode SE is transmitted to the first electrode E1 (pixel-electrode) through the active pattern AP and the drain electrode DE.

The second substrate 20 includes a second base substrate 21, a black matrix BM, a color filter CF, and a second electrode E2. In the present exemplary embodiment, the black matrix BM is arranged on the second base substrate 21 to block a light, the color filter CF is arranged on the second base substrate 21 to filter the light into a desired color band (e.g., Red, Green or Blue), and the second electrode E2 is arranged on the second base substrate 21 to cover the black matrix BM and the color filter CF.

The first substrate 10 further includes the first alignment layer 15 arranged at an uppermost portion of the first substrate 10 that makes contact with the liquid crystal layer 30, and the second substrate 20 further includes a second alignment layer 25 arranged at an uppermost portion of the second substrate 20 that makes contact with the liquid crystal layer 30.

The first alignment layer 15 has a rubbing direction that is substantially perpendicular to that of the second alignment layer 25 to thereby urge alignment of the first to third liquid crystal molecules LC1, LC2, and LC3 of the liquid crystal layer 30 in a progressive twisting manner. More detailed description of the above will be described with reference to FIG. 4.

FIG. 4 is a top plan view showing the liquid crystal display of FIG. 1.

Referring to FIGS. 1, 2, and 4, when viewed in a plan view, the rubbing direction of the first alignment layer 15 is substantially in parallel to the first direction D1, and the rubbing direction of the second alignment layer 25 is substantially in parallel to a second direction D2 that is substantially perpendicular to the first direction D1. Therefore, in the case that an electric field is not generated between the first and second electrodes E1 and E2, the first to third liquid crystal molecules LC1, LC2, and LC3 of the liquid crystal layer 30 (which liquid crystal layer is operated in the TN mode) are progressively twisted between the upper and lower substrates by 90 degrees, in other words, from being axially aligned in the first direction D1 to being axially aligned in the second direction D2 as seen in a top plan view while being substantially in parallel axially to the first substrate 10 and the second substrate 20.

More particularly, among the first to third liquid crystal molecules LC1, LC2, and LC3, the liquid crystal molecule positioned adjacent to the first alignment layer 15 with reference to a center of a cell-gap of the liquid crystal display 200 is defined as the first liquid crystal molecule LC1, the liquid crystal molecule positioned adjacent to the second alignment layer 25 with reference to the center of the cell-gap is defined as the second liquid crystal molecule LC2, and the liquid crystal molecule positioned adjacent to the center of the cell-gap is defined as the third liquid crystal molecule LC3. In this case, when the electric field is not generated between the first electrode E1 and the second electrode E2, a long axis direction of the first liquid crystal molecule LC1 is substantially in parallel to the first direction D1, a long axis direction of the second liquid crystal molecule LC2 (closest to the upper substrate) is substantially in parallel to the second direction D2, and a long axis direction of the intermediate third liquid crystal molecule LC3 is substantially in parallel to an intermediate third direction D3 that is about half way rotated between the first direction D1 and the second direction D2.

Meanwhile, a first angle a1 formed by a direction of a delay axis SA of the phase difference compensation film 60 and the second direction D2 is in a range of about 40 degrees to about 50 degrees in a clockwise direction with respect to the second direction D2. In the case that the delay axis SA direction is defined as above, the retardation of the phase difference generated in the liquid crystal layer 30 may be compensated by the phase difference compensation film 60 since a retardation direction of the phase difference generated by the electric field in the liquid crystal layer 30 is substantially the same as the third direction D3 that is the sum of the first direction D1 and the second direction D2.

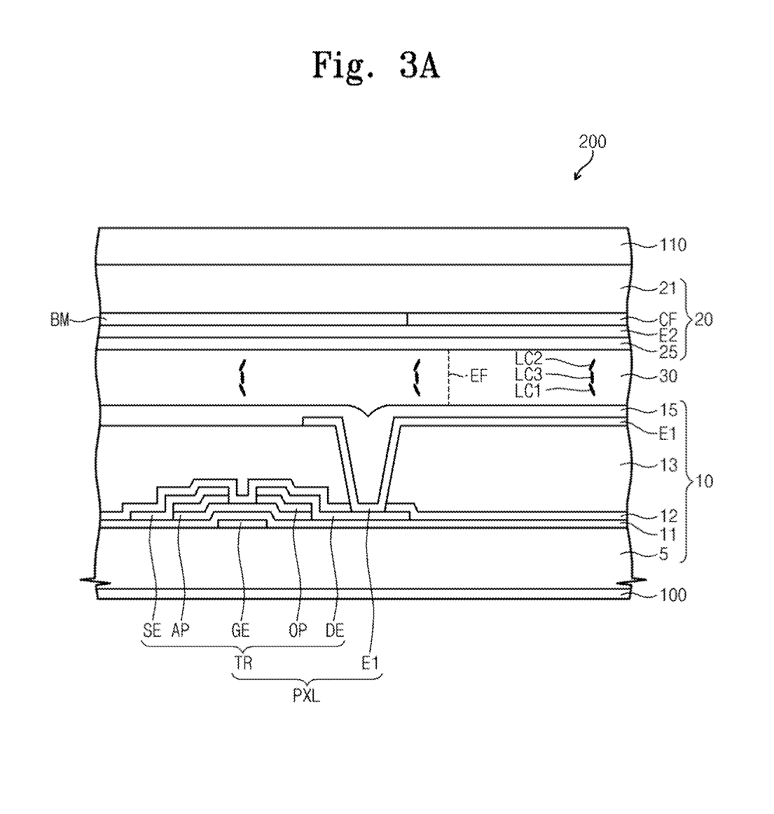

FIG. 3A is a cross-sectional view showing a pixel of the liquid crystal display when an electric filed is applied and the liquid crystal display is to display a black grayscale in that location. FIG. 3B is an enlarged view showing a elongated liquid crystal of FIG. 3A. In FIGS. 3A and 3B, the same reference numerals denote the same elements in previously-described exemplary embodiments, and thus the detailed descriptions of the same elements will be omitted.

Referring to FIG. 3A, when an electric field EF is generated between the first electrode E1 and the second electrode E2, each of the first, second, and third liquid crystal molecules LC1, LC2, and LC3 is arranged generally in parallel to the electric field EF, however, alignment directions of the first to third liquid crystals LC1, LC2, and LC3 may be different from each other (less than ideal).

In detail, referring to FIG. 3B, when an axis that is substantially in parallel to a first substrate 10 or a second substrate 20 is referred to as an x-axis and an axis that is substantially perpendicular to the x-axis and in parallel to the electric field EF is referred to as a Z-axis, a long axis of the third liquid crystal molecule LC3 may be substantially in parallel to the Z-axis by the electric field EF. That is, when no electric field EF exists, the long axis of the third liquid crystal molecule LC3 is substantially in parallel to the x-axis, and when the electric field EF exists, the long axis of the third liquid crystal molecule LC3 is rotated by about 90 degrees.

Also, when the electric field EF is not generated, a first long axis 35 of the first liquid crystal molecule LC1 is substantially in parallel to the x-axis, and when the electric field EF is generated, the first long axis 35 is tilted to be parallel to the Z-axis. However, unlike the third liquid crystal molecule LC3, a first tilt angle TA1 of about 2 degrees or less may be formed between the first long axis 35 and the Z-axis. When the first liquid crystal molecule LC1 is tilted, since the first liquid crystal molecule LC1 is closer to a first alignment layer 15 than the third liquid crystal molecule LC3 is closer to the first alignment layer 15, the first liquid crystal molecule LC1 may be interfered by a rubbing pattern formed on the first alignment layer 15, thereby forming the first tilt angle TA1.

In addition, when the electric field EF is not generated, a second long axis 36 of the second liquid crystal molecule LC2 is substantially in parallel to the x-axis, and when the electric field EF is generated, the second long axis 36 is tilted to be parallel to the Z-axis. However, similar to the first liquid crystal molecule LC1, the second liquid crystal molecule LC2 may be interfered by the rubbing pattern formed on the second alignment layer 25, and thus a second tilt angle TA2 of about 2 degrees or less may be formed between the second long axis 36 of the second liquid crystal molecule LC2 and the Z-axis.

As described above, when the electric field EF is generated, the first tilt angle TA1 and the second tilt angle TA2 may be formed, so that the phase difference of the light transmitting through the liquid crystal layer 30 may be changed. However, the phase difference of the light transmitting through the liquid crystal layer 30 may be compensated by the phase difference compensation film 60 (shown in FIG. 1) as described with reference to FIG. 4.

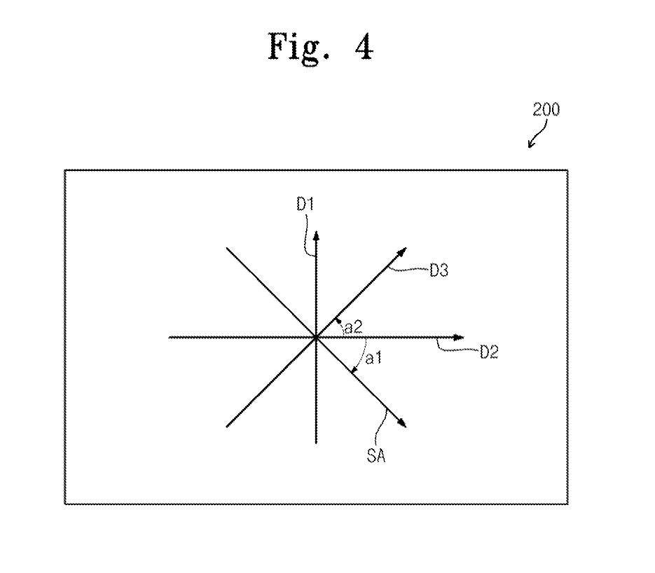

FIG. 5 is a graph showing a change in contrast ratio (black pixel versus white background) of a liquid crystal display according to a level of a driving voltage. More particularly, first to fifth graphs G1, G2, G3, G4, and G5 represent a contrast ratio of the liquid crystal display according to the level of the driving voltage when phase difference compensation films having different phase difference values in a surface direction are applied to the liquid crystal display.

The compensation film (60) phase difference values in the surface direction of the first to fifth graphs G1˜G5 are as follows.

| | 1st | 2nd | 3rd | 4th | 5th |
|---|---|---|---|---|---|
| | graph | graph | graph | graph | graph |
| | (G1) | (G2) | (G3) | (G4) | (G5) |
| phase difference value | 0 nm | 2.4 nm | 4.8 nm | 7.2 nm | 9.6 nm |
| in the surface direction | | | | | |
| of a phase difference | | | | | |
| compensation film | | | | | |

Referring to the first graph G1, the liquid crystal display (LCD) of that embodiment requires a relatively large driving voltage of about 3.7 volt in order to display a contrast ratio of about 1000 or better. However, referring to the second to fifth graphs G2, G3, G4, and G5, the LCD's of those respective embodiments may display the contrast ratio of about 1000 with the driving voltage of less than about 3.7 volt.

In detail, referring to the second graph G2, that LCD may display the contrast ratio of about 1000 or higher with the driving voltage of about 3.0 volt and higher. Referring to the third graph G3, that LCD may display the contrast ratio of about 1000 or higher with the driving voltage of about 2.8 volt and higher. Referring to the fourth and fifth graphs G4 and G5, those respective LCD's may display the contrast ratio of about 1000 with respective driving voltages in a range of about 2.7 volt to about 2.8 volt.

In the case that the phase difference value in the surface direction of the phase difference compensation film is zero (0), that is, when that LCD (G1) does not include the phase difference compensation film 60, the relatively driving voltage of about 3.7 volt is required to realize the contrast ratio of about 1000. However, as described in the present exemplary embodiment, when the LCD (G2-G5) includes the phase difference compensation film 60 having the phase difference value of about 3 nanometers to about 15 nanometers in the surface direction, the contrast ratio of about 1000 may be realized with the driving voltage about 3.0 volt or less. As those skilled in the art will recognize from the above, the reduced driving voltage for realizing a high contrast ratio (e.g., 1000 or greater) can advantageously result in reduced power consumption by an LCD that has constantly changing imagery.

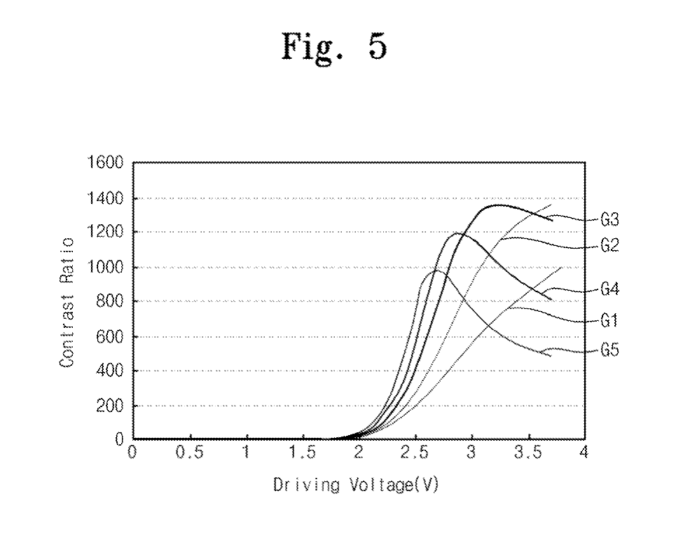

FIG. 6 is a cross-sectional view showing a liquid crystal display according to a second exemplary embodiment in accordance with the present disclosure. In FIG. 6, when compared to the liquid crystal display 200 (shown in FIG. 1) described with reference to FIGS. 1 to 5, a liquid crystal display 201 according to the present exemplary embodiment includes a first polarizing plate 101 having a sub-phase difference compensation film 61. Accordingly, a structure of the first polarizing plate 101 will be mainly described in detail with reference to FIG. 6. Further, in FIG. 6, the same reference numerals denote the same elements in FIGS. 1 to 5, and thus, the detailed descriptions of the same elements will be omitted.

Referring to FIG. 6, the liquid crystal display 201 includes a first substrate 10, a second substrate 20, a first polarizing plate 101, a second polarizing plate 110, a liquid crystal layer 30, and a backlight unit 150.

The first polarizing plate 101 is attached to the first substrate 10 to face the liquid crystal layer 30 while interposing the first substrate 10 therebetween. The first polarizing plate 101 includes a first polarizing film 40, a first protective film 71, and the sub-phase difference compensation film 61 instead of including the second protective film 72 (shown in FIG. 1).

The sub-phase difference compensation film 61 is arranged between the first substrate 10 and the first polarizing film 40. Similar to the phase difference compensation film 60 described with reference to FIGS. 1 to 5, the sub-phase difference compensation film 61 may compensate for a phase difference of a light LT, which is generated by the liquid crystal layer 30, when an electric field is generated between the first substrate 10 and the second substrate 20. Therefore, a retardation of the phase difference caused by the liquid crystal layer 30 may be compensated by the phase difference compensation film 60 and the sub-phase difference compensation film 61, thereby reducing a driving voltage required for the liquid crystal display 201 to display a contrast ratio of about 1000 or higher.

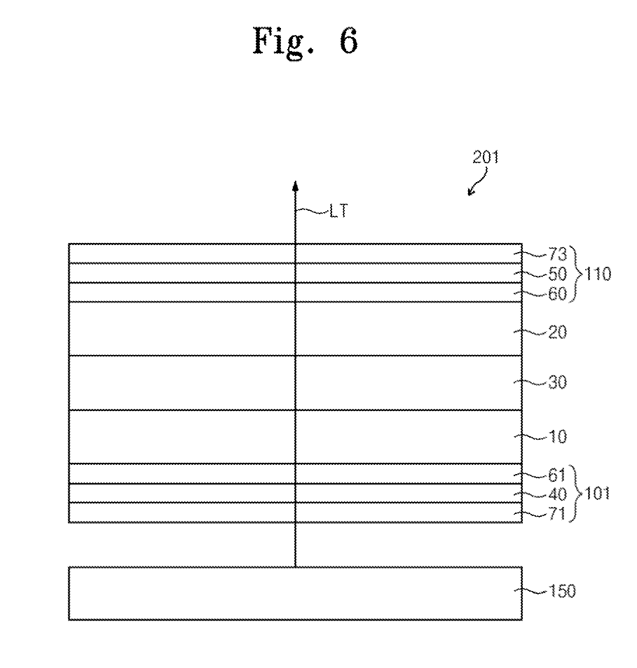

FIG. 7 is a cross-sectional view showing a liquid crystal display according to a third exemplary embodiment in accordance with the disclosure. When compared to the liquid crystal display 200 (shown in FIG. 1) described with reference to FIGS. 1 to 5, a liquid crystal display 202 of FIG. 7 includes a first polarizing plate 102 having a first viewing angle compensation film 80 and a second polarizing plate 112 having a second viewing angle compensation film 85. Thus, in FIG. 7, a structure of each of the first and second polarizing plates 102 and 112 will be mainly described in detail. In FIG. 7, the same reference numerals denote the same elements in FIGS. 1 to 5, and thus, the detailed descriptions of the same elements will be omitted.

Referring to FIG. 7, the liquid crystal display 202 includes a first substrate 10, a second substrate 20, a first polarizing plate 102, a second polarizing plate 112, a liquid crystal layer 30, and a backlight unit 150.

The first polarizing plate 102 is attached to the first substrate 10 to face the liquid crystal layer 30 while interposing the first substrate 10 therebetween. The first polarizing plate 102 includes a first polarizing film 40, a first protective film 71, and a first viewing angle compensation film 80 which replaces the second protective film 72 (shown in FIG. 1).

The first viewing angle compensation film 80 is arranged between the first substrate 10 and the first polarizing film 40. The first viewing compensation film 80 compensates for a phase difference of a light incident to the first substrate 10 while being inclined to the first substrate 10 (less than ideally normal to that substrate). In the present exemplary embodiment of FIG. 7, the first viewing angle compensation film 80 may be an A-plate, a B-plate, or a C-plate.

The second polarizing plate 112 includes a second viewing angle compensation film 85, a phase difference compensation film 60, a second polarizing film 50, and a third protective film 73.

As shown in FIG. 7, in the case that the second polarizing plate 112 includes the second viewing angle compensation film 85, the phase difference compensation film 60 is arranged between the second polarizing film 50 and the second viewing angle compensation film 85. Similar to the first viewing angle compensation film 80, the second viewing angle compensation film 85 compensates for a phase difference of a light that is incident to the second substrate 20 while being inclined to the second substrate 20.

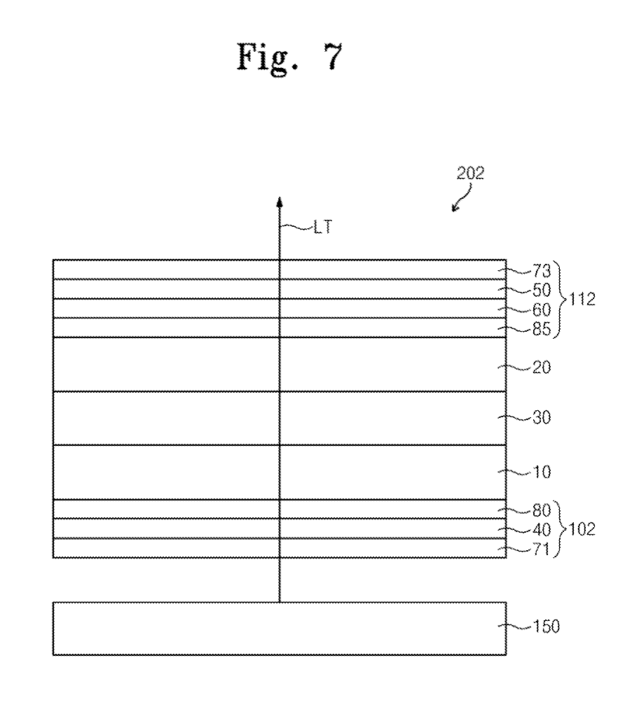

FIG. 8 is a perspective view of a polarizing plate according to a fourth exemplary embodiment in accordance with the disclosure.

Referring to FIG. 8, the polarizing plate 113 may be used in the liquid crystal display 200 (shown in FIG. 1) instead of the second polarizing plate 110 (shown in FIG. 1) described with reference to FIGS. 1 to 4.

The polarizing plate 113 includes a polarizing film 41, a protective film arranged on the polarizing film 41, and a phase difference compensation film 62 facing the protective film 74 while interposing the polarizing film 41 therebetween.

The polarizing film 41, the protective film 74, and the phase difference compensation film 62 have the same structure as the second polarizing film 50 (shown in FIG. 1), the second protective film 72, the phase difference compensation film 60 (shown in FIG. 1), respectively. That is, the phase difference compensation film 62 may have a phase difference value of about 3 nanometers to about 15 nanometers in a surface direction.

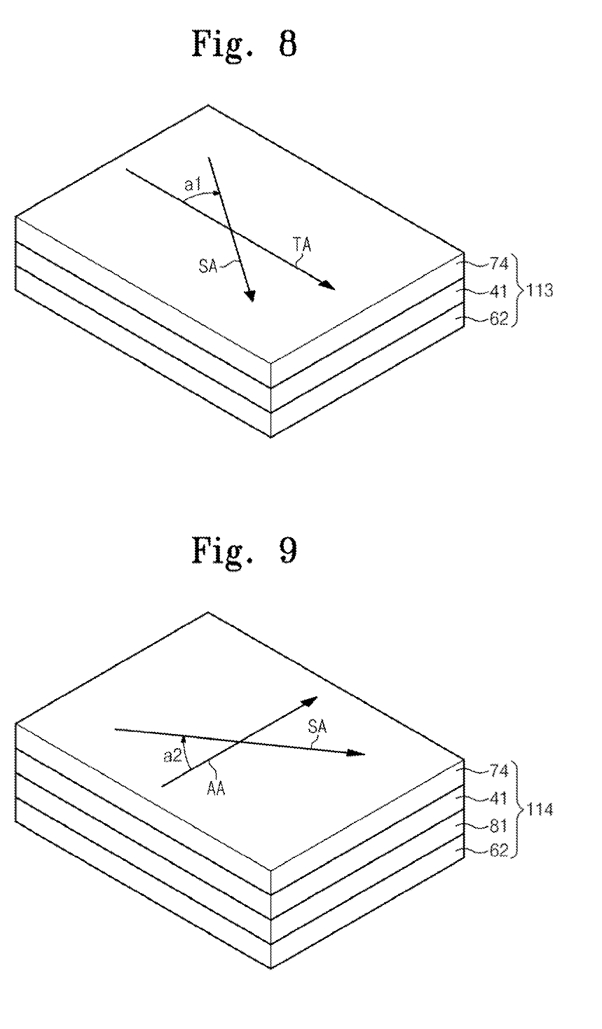

Meanwhile, unlike the previously-described exemplary embodiments with reference to FIGS. 1 to 4, when a rubbing direction of the second substrate 20 (shown in FIG. 1) may not be defined, the rubbing direction of the second substrate 20 may be in parallel to a transmission axis TA of the polarizing film 41 under the assumption that the polarizing plate 113 does not have a viewing angle compensation film 81 (refer to FIG. 9). Therefore, a first angle a1 formed by a delay axis SA of the phase difference compensation film 62 and the transmission axis TA of the polarizing film 41 is in a range of about 40 degrees to about 50 degrees in a clockwise direction with respect to the transmission axis TA.

FIG. 9 is a perspective view showing a polarizing plate according to a fifth exemplary embodiment in accordance with the disclosure. When compared to the polarizing plate 113 of FIG. 8, a polarizing film 114 described in FIG. 9 further includes a viewing angle compensation film 81. In FIG. 9, the same reference numerals denote the same elements in FIG. 8, and thus the detailed descriptions of the same elements will be omitted.

Referring to FIG. 9, the liquid crystal display 202 (shown in FIG. 7) may employ a polarizing plate 114 instead of the second polarizing plate 112 of FIG. 7.

The polarizing plate 114 includes a phase difference compensation film 62, a viewing angle compensation film 81, a polarizing film 41, and a protective film 74. The viewing angle compensation film 81, the polarizing film 41, and the protective film 74 are sequentially stacked on the phase difference compensation film 62.

Meanwhile, unlike the previous exemplary embodiments described with reference to FIGS. 1 to 4, when a rubbing direction of the second substrate 20 (shown in FIG. 1) may not be defined, the rubbing direction of the second substrate 20 may be in parallel to an absorption axis AA of the polarizing film 41 under the assumption that the polarizing plate 114 includes the viewing angle compensation film 81. Therefore, a second angle a2 formed by a delay axis SA of the phase difference compensation film 62 and the absorption axis AA of the polarizing film 41 is in a range of about 40 degrees to about 50 degrees in a clockwise direction with respect to the absorption axis AA.

Although the exemplary embodiments in accordance with the disclosure have been described, it is understood that the present teachings should not be limited to these exemplary embodiments but that, given the present disclosure, various changes and modifications can be made by one ordinary skilled in the art within the spirit and scope of the present teachings.

What is claimed is:

1. A liquid crystal display structured to display an image using a light passed through a liquid crystal material layer of the display, the display comprising:
a first substrate having a first liquid crystal aligning layer;
a second substrate disposed above and facing the first substrate and having a second liquid crystal aligning layer;
a liquid crystal layer disposed between the first and second substrates and including liquid crystal molecules operable in a twisted nematic mode;
a first polarizing film disposed below the liquid crystal layer;
a second polarizing film disposed above the liquid crystal layer; and
a phase difference compensation film disposed between the second polarizing film and the second substrate and configured to compensate for an undesired phase difference imposed on light passing through the liquid crystal layer when the liquid crystal layer is operating in the twisted nematic mode with an ideally fully untwisting electric field being applied to the liquid crystal layer,
wherein the passing through light sequentially travels through the first substrate, the liquid crystal layer, the phase difference compensation film and the second substrate in the recited order, and the phase difference compensation film has a delay axis which forms an acute angle with a rubbing direction of the second liquid crystal aligning layer.

2. The liquid crystal display of claim 1, wherein the phase difference compensation film has a phase difference value in a surface direction corresponding to but countering a phase difference generated by the liquid crystal layer when the liquid crystal layer is subjected to the ideally fully untwisting electric field.

3. The liquid crystal display of claim 2, wherein the phase difference value in the surface direction of the compensation film is about 3 nanometers to about 15 nanometers.

4. The liquid crystal display of claim 3, wherein the phase difference compensation film has a thickness of about 40 micrometers to about 80 micrometers.

5. The liquid crystal display of claim 1, wherein the first substrate comprises a first electrode, the second substrate comprises a second electrode to form an electric field with the first electrode between the first and second substrates.

6. The liquid crystal display of claim 1, wherein the acute angle is in a range of about 40 degrees to about 50 degrees, and the acute angle is rotated in a clockwise direction with respect to the rubbing direction as virtually seen in a plan view while the undesired phase difference imposed by the liquid crystal layer when the liquid crystal layer is subjected to an ideally fully untwisting electric field is in the counter-clockwise direction.

7. The liquid crystal display of claim 1, further comprising a viewing angle compensation film disposed between the phase difference compensation film and the liquid crystal layer.

8. A polarizing plate structured for inclusion in a liquid crystal display having a liquid crystal layer operating in a twisted nematic mode to display an image, the polarizing plate comprising:
a polarizing film having a transmission axis; and
a phase difference compensation film attached to the polarizing film and having a delay axis that forms an acute angle with the transmission axis in a plan view, the phase difference compensation film being disposed to receive light that has traveled through the liquid crystal layer first before that light is incident upon the polarizing film.

9. The polarizing plate of claim 8, wherein the phase difference compensation film has a phase difference value of about 3 nanometers to about 15 nanometers in a surface direction.

10. The polarizing plate of claim 9, wherein the phase difference compensation film has a thickness of about 40 micrometers to about 80 micrometers.

11. The polarizing plate of claim 8, wherein the acute angle is in a range of about 40 degrees to about 50 degrees and the delay axis is rotated in a clockwise direction with respect to the transmission axis in a plan view.

12. A polarizing plate for a liquid crystal display having a liquid crystal layer that is operable in a twisted nematic mode to display an image, the polarizing plate comprising:
a polarizing film having an absorption axis;
a phase difference compensation film attached to the polarizing film and having a delay axis that forms an acute angle with the absorption axis in a plan view; and
a viewing angle compensation film facing the polarizing film while interposing the phase difference compensation film therebetween.

13. The polarizing plate of claim 12, wherein the phase difference compensation film has a phase difference value of about 3 nanometers to about 15 nanometers in a surface direction.

14. The polarizing plate of claim 13, wherein the phase difference compensation film has a thickness of about 40 micrometers to about 80 micrometers.

15. The polarizing plate of claim 12, wherein the acute angle is in a range of about 40 degrees to about 50 degrees and the delay axis is rotated in a clockwise direction with respect to the transmission axis in a plan view.
